(19) United States
(12) Patent Application Publication
(10) Pub. No.: US 2024/0318674 A1
(43) Pub. Date: Sep. 26, 2024

(54) PISTON AND CYLINDER DEVICE WITH STROKE CUSHIONING

(71) Applicant: Hydra Dyne Technology Inc., Ingersoll (CA)

(72) Inventors: Stephan E. BOHNER, Woodstock (CA); Robert KROPINIEWICZ, London (CA)

(73) Assignee: Hydra Dyne Technology Inc., Ingersoll, ON (CA)

(21) Appl. No.: 18/681,547

(22) PCT Filed: Jul. 11, 2022
(86) PCT No.: PCT/CA2022/051077

§ 371 Date: Feb. 6, 2024

Related U.S. Application Data
(60) Provisional application No. 63/230,083, filed on Aug. 6, 2021.

(51) Int. Cl. F15B 15/22; F15B 15/14

(52) U.S. Cl. CPC F15B 15/22; F15B 15/1428; F15B 15/1457

(57) ABSTRACT

A rod for a piston and cylinder device has a rod spud having a spiral channel in an outer surface thereof. The spiral channel spirals around the rod spud in a longitudinal direction. The spiral channel provides a hydraulic fluid flow path between an internal volume of a barrel and an internal volume of a spud receiver of the piston and cylinder device when the rod spud is in the spud receiver. At least a portion of the spiral channel has a cross-sectional area that decreases continuously and gradually as the spiral channel spirals longitudinally away from a distal end of the rod spud. The spiral channel provides more controlled deceleration of the hydraulic cylinder rod until the end of the retraction stroke.

### CROSS-REFERENCE TO RELATED APPLICATIONS

This application claims the benefit of United States Provisional Patent Application U.S. Ser. No. 63/230,083 filed Aug. 6, 2021, the entire contents of which is herein incorporated by reference.

### FIELD

This application relates to piston and cylinder devices, more particularly to a rod having a rod spud for cushioning an end stroke movement of a piston and cylinder device.

### BACKGROUND

It is common practice to utilize cushioning devices in a piston and cylinder device (e.g., a hydraulic cylinder, hydraulic jack and the like) to prevent high velocity contact of the piston and cylinder head. Such cushioning devices may utilize a spud receiver with a cushion sleeve, which restricts the passage of fluid into an exit port. Such restriction causes back pressure on the piston, thereby slowing the piston at the end of the piston's stroke.

However, such cushioning devices provide deceleration only until the piston has traveled to within a very short distance of the cylinder head and may not dissipate enough of the velocity of the piston before reaching the cylinder head. This can cause damage to the cylinder head.

Attempts to improve the cushioning of the piston have been made in the art. For example, U.S. Pat. No. 3,964,370 describes a cushioning arrangement in which a rod spud is provided with steps to periodically reduce the diameter of the spud. However, such an arrangement does not provide an ideal cushioning, rather results in pressure fluctuations during cushioning of the piston as the piston approaches the end of the stroke.

International patent publication WO 2020/237344 published Dec. 3, 2020, the entire contents of which is herein incorporated by reference, describes a piston and cylinder device wherein the rod spud has an outer surface and a base end cushion sleeve comprises an inner surface, the outer surface of the rod spud and the inner surface of the cushion sleeve defining an annular orifice between the internal volume of the barrel and an interior of the cushion sleeve, the annular orifice having a cross-sectional area that dynamically, continuously and gradually decreases as the external tapered portion of the rod spud moves through the internal tapered portion of the cushion sleeve to the end of the piston stroke at the base, the annular orifice having a length that dynamically, continuously and gradually increases as the external tapered portion of the rod spud moves through the external tapered portion of the cushion sleeve to the end of the piston stroke at the base.

There remains a need for cushioning the end stroke of a piston and cylinder device in such a simpler manner that provides better control over and complete deceleration of the piston at the very end of the stroke.

### SUMMARY

A rod for a piston and cylinder device is provided, the rod comprising a rod spud having a spiral channel in an outer surface thereof, the spiral channel spiraling around the rod spud in a longitudinal direction, the spiral channel providing a hydraulic fluid flow path between an internal volume of a barrel and an internal volume of a spud receiver of the piston and cylinder device when the rod spud is in the spud receiver, and at least a portion of the spiral channel having a cross-sectional area that decreases continuously and gradually as the spiral channel spirals longitudinally away from a distal end of the rod spud.

A piston and cylinder device is provided, the device comprising: a barrel; a base mounted on a first end of the barrel, the base comprising a base hydraulic fluid port permitting flow of a hydraulic fluid into and out of the barrel from and to a hydraulic fluid circuit; a gland mounted on a second end of the barrel, the gland comprising a gland hydraulic fluid port permitting flow of the hydraulic fluid into and out of the barrel from and to the hydraulic fluid circuit; and, a piston assembly situated inside the barrel, the piston assembly comprising a piston mounted on a piston rod, the piston assembly moveable along a longitudinal axis of the barrel under hydraulic fluid pressure in the barrel to permit piston strokes between the base and the gland, wherein the piston rod comprises a rod spud, and the base comprises a spud receiver for receiving the rod spud as the piston assembly approaches an end of the piston stroke at the base, wherein the rod spud comprises a proximal end and a distal end, the proximal end situated closer to the piston than the distal end, wherein the rod spud comprises a spiral channel in an outer surface thereof, the spiral channel spiraling around the rod spud in a longitudinal direction, the spiral channel providing a hydraulic fluid flow path between an internal volume of the barrel and an internal volume of the spud receiver of the piston and cylinder device when the rod spud is in the spud receiver, and at least a portion of the spiral channel having a cross-sectional area that decreases continuously and gradually as the spiral channel spirals longitudinally away from the distal end of the rod spud.

Preferably, the piston and cylinder device is a hydraulic cylinder, hydraulic jack or the like.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a side view of a hydraulic cylinder rod having a rod spud with a spiral channel.

FIG. 2 depicts a magnified view of the rod spud shown in FIG. 1 from an opposite side of the hydraulic cylinder rod.

FIG. 3A depicts a perspective view of a hydraulic cylinder comprising the hydraulic cylinder rod of FIG. 1, wherein, in a cut-away, the rod spud is shown partially in a spud receiver at a base of the hydraulic cylinder.

FIG. 3B depicts a side view of the hydraulic cylinder of FIG. 3A.

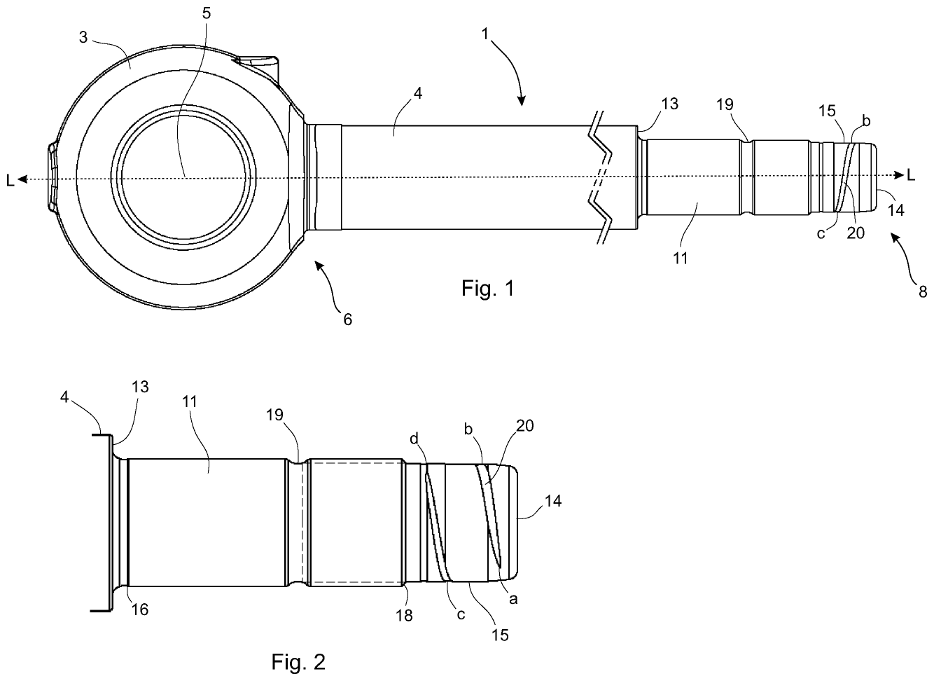

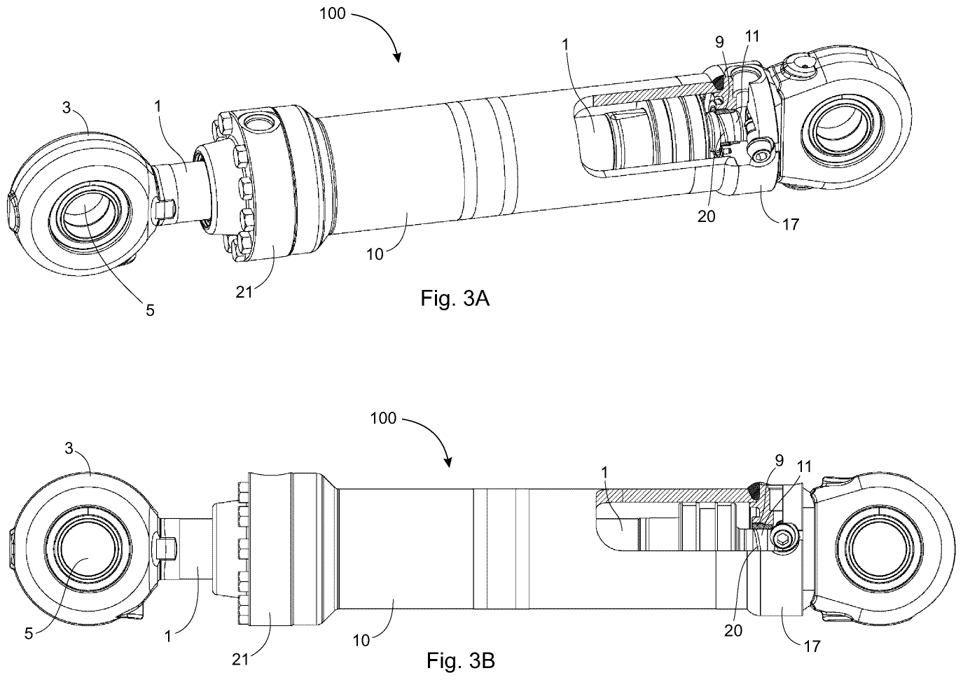

### DETAILED DESCRIPTION

With reference to the Figures, a hydraulic cylinder 100 comprises a main barrel 10 having a base 17 mounted on the barrel 10 at a first end of the barrel 10, a gland 21 mounted at a second end of the main barrel 10, and a hydraulic cylinder rod 1 for disposed through the gland 21 into the main barrel 10. The hydraulic cylinder rod 1 comprises a cap 3 having an eye 5 therethrough a a gland end 6 of the hydraulic cylinder rod 1 outside the hydraulic cylinder 100, and a rod spud 11 at a base end 8 of the hydraulic cylinder rod 1 inside the hydraulic cylinder 100. The hydraulic cylinder rod 1 has a longitudinal axis L-L.

The rod spud 11 is generally not tapered, except for having a bullnose at a distal end 14 thereof, a slight stepdown taper 18 at a location between the distal end 14 and a proximal end 16 of the rod spud 11, and an annular groove 19, which serves as a seat for an O-ring. The distal end 14 of the rod spud 11 is at the base end 8 of the hydraulic cylinder rod 1, while the proximal end 16 of the rod spud 11 is closer toward the gland end 6 of the hydraulic cylinder rod 1. The rod spud 11 has a smaller diameter than a diameter of a main portion 4 of the hydraulic cylinder rod 1. During a retraction stroke, the rod spud 11 moves into a spud receiver 9 in the base 17 having a smaller diameter than the main barrel 10. Movement of the rod spud 11 into the spud receiver 9 produces a back pressure of hydraulic fluid on the rod 1 thereby slowing the speed of the rod 1 until the rod 1 stops at the end of the retraction stroke with the rod spud 11 fully seated in the spud receiver 9 with the spud receiver 9 sealed against a base end face 13 of the main portion 4 of the hydraulic cylinder rod 1. Although the spud receiver 9 slows the hydraulic cylinder rod 1 near the end of the retraction stroke, deceleration is only provided until the rod 1 has traveled to within a very short distance of the base 17, after which velocity not dissipated causes an overly abrupt stop at the end of the stroke.

To mitigate against the abrupt stop at the end of the retraction stroke, the rod spud 11 is provided with a spiral channel 20 in and around an outer surface 15 of the rod spud 11 proximate the distal end 14 of the rod spud 11. The spiral channel 20 provides a hydraulic fluid flow path between an internal volume of the main barrel 10 and an internal volume of the spud receiver 9. The spiral channel 20 has a geometry that keeps the hydraulic fluid back pressure constant during deceleration of the hydraulic cylinder rod 1 until the end of the retraction stroke, where the hydraulic fluid back pressure abruptly drops as the hydraulic cylinder rod 1 stops. Further, there is no, or only an insignificant, spike in hydraulic fluid back pressure when the hydraulic cylinder rod 1 reaches the end of the retraction stroke, which ensures that the base 17 is not damaged at the end of the retraction stroke.

To this end, at least a portion of the spiral channel 20 gradually becomes narrower and shallower as the spiral channel 20 spirals longitudinally away from the distal end 14 of the rod spud 11. As the spiral channel 20 gradually becomes narrower and shallower, the cross-sectional area of the spiral channel 20 gradually decreases. In some embodiments, the spiral channel 20 is wider and deeper (i.e., larger cross-sectional area) in a central portion of the spiral channel 20 in comparison to distal and proximal ends of the spiral channel 20. For example, the spiral channel 20 may start narrow and shallow at point a, which is the distal end of the spiral channel 20 and is closest to the distal end 14 of the rod spud 11, gradually becoming wider and deeper (i.e., increasing cross-sectional area) to point b and then gradually becoming narrower and shallower (i.e., decreasing cross-sectional area) as the spiral channel 20 spirals longitudinally from point b to point c through to point d at the proximal end of the spiral channel 20, which is furthest from the distal end 14 of the rod spud 11. When the hydraulic cylinder rod 1 is retracted and the rod spud 11 has entered the spud receiver 9, hydraulic fluid flows from the internal volume of the spud receiver 9 at the distal end 14 of the rod spud 11 through the spiral channel 20 into the main barrel 10. Because at least a portion of the spiral channel 20 narrows and becomes shallower (i.e., decreases in cross-sectional area) longitudinally away from the distal end 14 of the rod spud 11, there is a dynamic, continuous and gradual decrease in the amount of hydraulic fluid passing through the spiral channel 20 as the rod spud 11 progresses to the end of the spud receiver 9. The dynamic, continuous and gradual decrease in the amount of hydraulic fluid flowing through the spiral channel 20 from the spud receiver 9 to the main barrel 10 provides a more controlled deceleration rate of the hydraulic cylinder rod 1 during the deceleration of the hydraulic cylinder rod 1 until the end of the retraction stroke. In addition, the spiral channel 20 acts as a pressure relief during deceleration of the hydraulic cylinder rod 1.

Using the spiral channel 20 permits creation of a hydraulic fluid path having sufficient volume and a cross-sectional area that decreases sufficiently gradually over the path to permit a properly controlled hydraulic fluid flow into the spiral channel 20 to ensure that there is a well-controlled deceleration of the hydraulic cylinder rod 1 until the hydraulic cylinder rod 1 reaches the end of the retraction stroke. In a preferred embodiment, the volume of fluid that can pass through the spiral channel 20 is 5.93091e⁻⁸ m³, and a length that has a pitch of 1.5 turns over a length of the rod spud 11.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A rod for a piston and cylinder device, the rod comprising a rod spud having a spiral channel in an outer surface thereof,
the spiral channel spiraling around the rod spud in a longitudinal direction,
the spiral channel providing a hydraulic fluid flow path between an internal volume of a barrel and an internal volume of a spud receiver of the piston and cylinder device when the rod spud is in the spud receiver, and
at least a portion of the spiral channel having a cross-sectional area that decreases continuously and gradually as the spiral channel spirals longitudinally away from a distal end of the rod spud.

2. The device of claim 1, wherein an amount of hydraulic fluid passing through the spiral channel as the rod spud progresses to an end of the spud receiver during a stroke of the rod decreases dynamically, continuously and gradually as a result of the continuous and gradual decrease of the cross-sectional area of the spiral channel.

3. A piston and cylinder device comprising:
a barrel;
a base mounted on a first end of the barrel, the base comprising a base hydraulic fluid port permitting flow of a hydraulic fluid into and out of the barrel from and to a hydraulic fluid circuit;
a gland mounted on a second end of the barrel, the gland comprising a gland hydraulic fluid port permitting flow of the hydraulic fluid into and out of the barrel from and to the hydraulic fluid circuit; and,
a piston assembly situated inside the barrel, the piston assembly comprising a piston mounted on a rod as defined in claim 1, the piston assembly moveable along a longitudinal axis of the barrel under hydraulic fluid pressure in the barrel to permit piston strokes between the base and the gland,
wherein the base comprises a spud receiver for receiving the rod spud of the rod as the piston assembly approaches an end of the piston stroke at the base.

4. A piston and cylinder device comprising:
a barrel;
a base mounted on a first end of the barrel, the base comprising a base hydraulic fluid port permitting flow of a hydraulic fluid into and out of the barrel from and to a hydraulic fluid circuit;
a gland mounted on a second end of the barrel, the gland comprising a gland hydraulic fluid port permitting flow of the hydraulic fluid into and out of the barrel from and to the hydraulic fluid circuit; and,
a piston assembly situated inside the barrel, the piston assembly comprising a piston mounted on a rod as defined in claim 2, the piston assembly moveable along a longitudinal axis of the barrel under hydraulic fluid pressure in the barrel to permit piston strokes between the base and the gland,
wherein the base comprises a spud receiver for receiving the rod spud of the rod as the piston assembly approaches an end of the piston stroke at the base.
